(19) United States
(12) Patent Application Publication
(10) Pub. No.: US 2025/0190575 A1
(43) Pub. Date: Jun. 12, 2025

(54) ASSESSING SBOM ACCURACY AND COMPLETENESS

(71) Applicant: INTERNATIONAL BUSINESS MACHINES CORPORATION, Armonk, NY (US)

(72) Inventors: Dhilung Hang Kirat, Hartsdale, NY (US); Douglas Lee Schales, Ardsley, NY (US); Jiyong Jang, Chappaqua, NY (US); Ian Michael Molloy, Westchester, NY (US); Ted Augustus Habeck, Hopewell Junction, NY (US); Yue Xiao, Bloomington, IN (US); Josyula R. Rao, Ossining, NY (US)

(21) Appl. No.: 18/530,424

(22) Filed: Dec. 6, 2023

(51) Int. Cl. G06F 21/57; G06F 8/41; G06F 16/33

(52) U.S. Cl. CPC G06F 21/577; G06F 8/433; G06F 16/3347; G06F 2221/033

(57) ABSTRACT

Methods and systems for assessing a software bill of materials (SBOM) include building a knowledge graph from repositories, using function fingerprints of software packages in the repositories. Dependencies of an application are identified using function fingerprints of the application and comparing to function fingerprints of the software packages. A quality score for an SBOM of the application is generated based on a comparison of the identified dependencies to claimed dependencies of the SBOM. An action is performed responsive to the quality score.

### BACKGROUND

The present invention generally relates to software dependency analysis and, more particularly, to assessing a software bill of materials (SBOM).

Complex software may involve a network of interdependencies, where any code unit can leverage software from a variety of different sources. This complexity is magnified by dependencies and transitive dependencies, which poses a security risk in the event that a software package in the supply chain is attacked. Such an attack may target a widely used component, and render downstream software vulnerable as well.

An SBOM functions as a list of components for software that catalogs the modules, libraries, and components used in building and using the software. This provides transparency so that vulnerabilities can be identified and patched, thereby improving the security and integrity of the software supply chain. However, the utility of an SBOM is limited by its accuracy and completeness, as an incomplete or inaccurate SBOM may mislead downstream software consumers, leading them to misjudge potential security risks.

### SUMMARY

A method for assessing a software bill of materials (SBOM) includes building knowledge graph from repositories, using function fingerprints of software packages in the repositories. Dependencies of an application are identified using function fingerprints of the application and comparing to function fingerprints of the software packages. A quality score for an SBOM of the application is generated based on a comparison of the identified dependencies to claimed dependencies of the SBOM. An action is performed responsive to the quality score.

A system for assessing an SBOM includes a hardware processor and a memory that stores a computer program. When executed by the hardware processor, the computer program causes the hardware processor to build a knowledge graph from a plurality of repositories, using function fingerprints of software packages in the plurality of repositories, to identify dependencies of an application using function fingerprints of the application and comparing to function fingerprints of the software packages, to generate a quality score for an SBOM of the application based on a comparison of the identified dependencies to claimed dependencies of the SBOM, and to perform an action responsive to the quality score.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram illustrating a dependency tree for a software application that is represented by a software bill of materials (SBOM), in accordance with an embodiment of the present invention;

FIG. 2 is a block/flow diagram of a method for assessing and responding to a SBOM, in accordance with an embodiment of the present invention;

FIG. 3 is a block/flow diagram of a method for building a knowledge graph of available software packages, in accordance with an embodiment of the present invention;

FIG. 4 is a block/flow diagram of a method for identifying dependencies of an application, in accordance with an embodiment of the present invention;

FIG. 5 is a block/flow diagram of a method for comparing identified dependencies of an application to claimed dependencies of an associated SBOM, in accordance with an embodiment of the present invention; and

FIG. 6 is a block diagram of a computing system that can perform SBOM assessment and response, in accordance with an embodiment of the present invention.

### DETAILED DESCRIPTION

The actual dependencies of a piece of software may be identified using code-level analysis of static binary code. These dependencies may be compared to corresponding software bills of materials (SBOMs) to identify inaccuracies and missing declarations. Rather than simply verifying the format of an SBOM file, a quality score may be generated based on the actual content of the software to specifically target missing or incorrect dependencies with security implications. Root causes for any inaccuracies and incompleteness may further by analyzed.

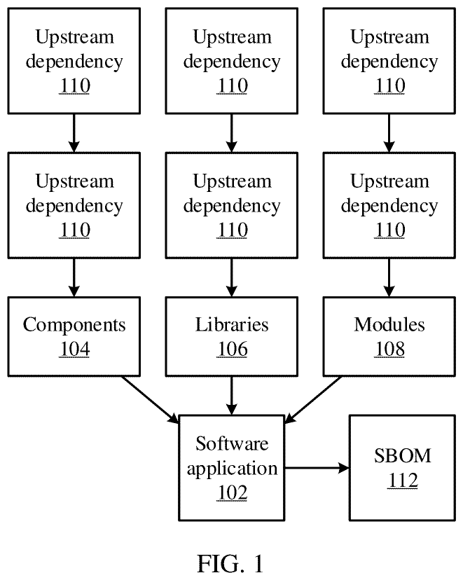

Referring now to FIG. 1, a diagram illustrates software dependencies in a software supply chain. A given software application 102 may be built using a variety of other software packages. For example, these software packages may include components 104, libraries 106, and modules 108. Each of these software packages may, in turn, have upstream dependencies 110 that they use. The upstream dependencies 110 may branch, with any given package depending from one or more upstream packages.

Each dependency may identify a particular software package as well as its version. Thus, a complete identification the dependencies of the software application 102 may include multiple different versions of a same package, and furthermore a given version of a given package may furthermore be used multiple times by multiple other packages.

The information regarding the dependencies of the software application 102 may be collected in an SBOM 112. There are a variety of tools that will generate an SBOM 112 for a given software application, but these tools may generate a high false-positive rate, for example due to their dependence on heuristic guesses and metadata. For example, some tools may extract dependencies from package managers, which may be manually specified by developers and which may fail to accurately identify all dependencies or may over-claim dependencies that remain unused through the software's lifecycle.

Some tools focus on the format of the SBOM 112, rather than its contents. These tools may evaluate the SBOM 112 according to industry-standard specification, and may judge the inclusion of identifiers, licenses, versioning information, and accurate documentation of component licenses. However, such evaluations do not extend to the accuracy and completeness of the content of the SBOM.

Manual verification of the SBOM 112 may be time-consuming and labor-intensive, particularly for large dependency networks, and may further lack consistency and reproducibility across different reviewers. Furthermore, manual verification still may not capture all of the dependencies for a software application 102, particularly in cases with deeply nested or transitive dependencies.

The SBOM 112 may therefore be automatically verified using an end-to-end approach that automatically evaluates the quality of realistic SBOMs that are provided by the developer of the software application 102. This automatic evaluation may be supplemented with in-depth case studies and root cause analysis for incomplete and inaccurate SBOMs. A knowledge graph may be used to aggregate data from multiple sources. The knowledge graph may be used in tandem with code fingerprinting to identify potential dependencies that include functions or other code that have the same fingerprint as code within an application, making it possible to automatically detect dependencies that were not declared in an SBOM.

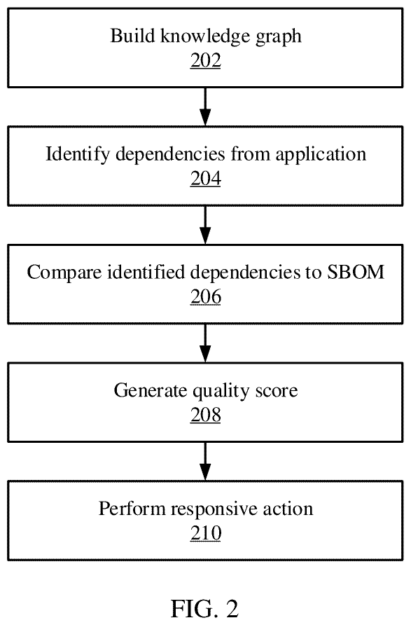

Referring now to FIG. 2, a method for assessing and responding to the quality of an SBOM is shown. Block 202 builds a knowledge graph based on a variety of software package sources. For example, these sources may include open source repositories, package management systems, packages' official websites, and organization-specific knowledge sources. Information from these varied sources may be combined into a knowledge graph that includes fingerprinting information for different components of a variety of software packages. The fingerprinting may, for example, identify fingerprint information for individual functions and classes within a software package, which can be used to match the functions of another software package.

For example, if a given application is similarly fingerprinted, and the application's function fingerprints are compared to those of a software package in the knowledge graph in block 204, then matches may indicate a dependency. Fingerprints can be compared to one another using any appropriate metric, so that two input fingerprints may generate a corresponding matching score. Matching scores above a threshold value may indicate that the application is dependent on a corresponding software package, as the application includes one or more functions from the software package. The identification of a dependency in block 204 may include the name of the software package, and may further include information such as version numbers and options that have been enabled.

The identified dependencies may be considered for their composition ratio and containment ratio. The composition ratio identifies what percent of the given software package is being used by the application, while the containment ratio identifies a percent of the application that is contained within the software package. Each of these ratios provides a respective measure of dependency. The composition ratio determines whether or not to include a matched and identified software package in an SBOM for the input application. For example, if 30% of a given package matches the code in the application, providing a containment ratio of 30%, then the package may be included as a dependency. If only 1% of the package's code matches the application, then that may not rise above the threshold for inclusion.

Once a set of dependencies has been identified, block 206 compares the identified dependencies to an SBOM for the application. The dependencies claimed by the SBOM may be evaluated as to whether it is a direct or a transitive dependency and its lifecycle phase may be determined. For an input application, only the direct dependencies can be identified by analyzing its code. Transitive dependencies may still be identified by looking to the knowledge graph to determine any packages relied on by the packages that are explicitly depended on by the application's code. The lifecycle phase may be useful for the quality score calculations for the second level of weights, based on the scope of the dependencies.

The comparison may identify dependencies that are missing from the SBOM, or that are inaccurately identified, for example using an incorrect version number. Based on the comparison, block 208 generates a quality score for the SBOM that characterizes its accuracy and completeness. Block 210 then performs an action responsive to the quality score.

Exemplary factors that may be considered in the quality score are inconsistency types, missing or inaccurate types, and the scopes of the dependencies. Recognizing missing or inaccurate dependencies can potentially lead to security risks, and further suggest varying levels of difficulty in implementing a fix. Furthermore, whether a dependency is required for compiling, runtime, testing, or some other purpose can influence the severity of a missing or inaccurate dependency. Each of these factors carries its own severity weight, and these weights together influence the overall quality score. The severity weights can be tailored to the specific needs of an organization.

For example, the quality score may be evaluated as:

$$score = 10 \times ( 1 - \frac{{\sum }_{i = 1}^{n} ( {w}_{1} [ i ] + {w}_{2} [ i ] ) \times counts [ i ]}{( max ( {w}_{1} ) + max ( {w}_{2} ) ) \times T} )$$

where w₁[i] is the level-1 weight for missing or inaccurate dependencies for the i^{th} record, w₂[i] is the level-2 weight for the scope of dependencies for the i^{th} record, counts[i] is the count for the specific combination of the two factors for the i^{th} record, Tis a predetermined total number of dependencies, and n is a number of records. Each record is a record of a dependency component in the SBOM that is found to be missing or inaccurate. The different level weights (e.g., w₁ and w₂) are determined for each respective record.

The formula integrates the weights from each type of consideration, the counts of each unique level combination, and a total number of dependencies. The score is normalized, using the maximum possible weight multiplied by the total dependencies, and reversed to ensure that higher scores signal higher SBOM quality. In this example the score is scaled to be between 1 and 10, but it should be understood that any appropriate scaling may be used instead.

Organizations can tailor the weights based on their specific requirements. For example, resource-constrained entities may prioritize weights toward inaccurate dependencies to minimize false alerts. Security-centric organizations may assign greater weights to missing dependencies to ensure that no vulnerabilities are overlooked.

Depending on where the software package is used, the responsive action may be tailored to correct the reflect the particular needs of the application. In some cases, a vendor may be informed of deficiencies in the SBOM. In other cases, the SBOM may be automatically augmented to correct inaccuracies and/or supplement omissions. For example, the SBOM may be automatically edited to add information relating to dependencies that were detected as being used by the program code, but that were omitted by the SBOM. In a further example, the corrective action 408 may disable an installed software package associated with the SBOM. This action may be appropriate in a highly trusted system where an inaccurate or incomplete SBOM may obscure a security vulnerability. In such a situation, the software package may be prevented from executing until an SBOM can be provided that has a quality score above an associated threshold.

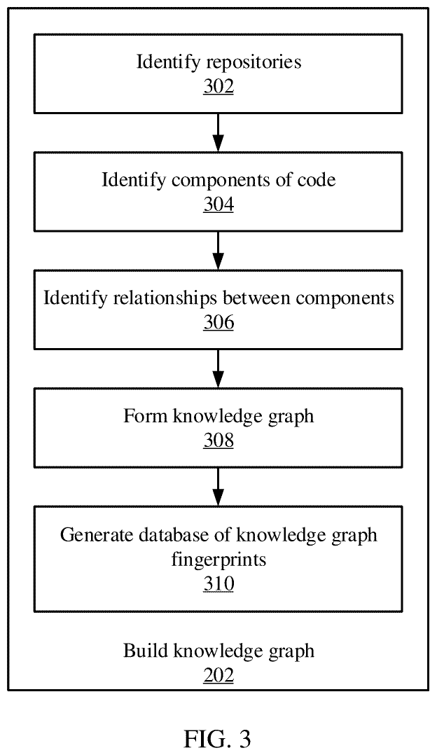

Referring now to FIG. 3, additional detail on building the knowledge graph in block 202 is shown. Block 302 identifies repositories of information about software packages. These repositories may include, for example, open source repositories, where heuristic criteria may be used to identify official repositories of open-source software projects. Such heuristics may include user ratings, fork status, and contributor count. Package managers may further be used, as they serve as central repositories for multiple software packages and related documentation. A detailed index of documents and other artifacts may be extracted from such package managers, with download links for each such artifact. Official websites for software packages may also be used, with download pages being identified to obtain the relevant software packages. Information relating to the software packages may be determined from the official website. Additional software may be available in internal repositories, which makes it possible for an organization to introduce their own unique artifacts to the knowledge graph.

Block 304 identifies components of code within the software packages extracted from the repositories. Such components may include, without limitation, functions, files, libraries, packages, and images. Block 306 identifies the relationships between components. For example, a given package may include multiple files, and each file may include multiple functions. These relationships may be used to relate the objects to one another in a knowledge graph by block 308, with each component being a node of the graph and with each identified relationship being an edge of the graph.

Block 310 generates a database of knowledge graph fingerprints. The components may each be fingerprinted to generate a representation that can be readily compared to other such fingerprints. For example, fingerprinting may include decompiling software to a raw intermediate representation. This intermediate representation may be converted to a canonical representation, for example by simplifying the automatically generated variable names. The canonical representation may be converted to bitcode, which may in turn be converted to a corresponding bitmap image. The image may then be embedded in a latent space using any appropriate embedding process, such as using a convolutional neural network to generate a fingerprint vector. Such vectors may be stored in the database, along with associated information of the software package. The database may be queried with an input fingerprint vector, where it may be compared to stored fingerprints by any appropriate metric, such as the cosine similarity metric.

When block 204 identifies the dependencies from an application being considered, the application may be fingerprinted in the same manner. Individual fingerprints may be used as queries to the vector database in block 206, with any entries having high match scores being returned with corresponding software package information.

Dependencies may take different forms. In a first example, a dependency of the application may be accurately identified in the SBOM for the application. In a second example, the dependency of the SBOM may be inaccurate, but there may be an equivalent package, for example differing by a minor version number.

Identifying missing dependencies may involve a deeper analysis. For example, the application may include one or more individual files that are equivalent to files in a particular software package, suggesting that the application in fact depends on the software package. In another example, the files may differ, but the application may include functions that are equivalent to functions in the software package. In this case, function fingerprinting may be used to identify matches between the functions of the application and functions in the knowledge graph. In another example, the functions may differ, but may nonetheless have fingerprints that are sufficiently similar to suggest a dependency. For example, if the application's developer copies source code from an open source software package, but modifies it for their own purposes, the function fingerprinting may indicate the similarity and identify the dependency.

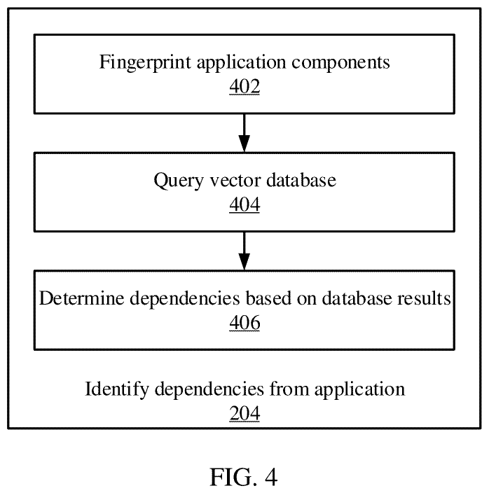

Referring now to FIG. 4, additional detail on the identification of dependencies 204 is shown. Block 402 fingerprints the components of the application. This process may use the same fingerprinting process that is used to build the knowledge graph, as in block 308 described above. Block 402 may therefore decompile the application into an intermediate representation, generate a canonical representation, generate a corresponding bitmap image, and embed the image to generate fingerprint vectors for the functions of the application.

The function fingerprints may be used to query the vector database that corresponds to the knowledge graph in block 404. These results may indicate matching functions, either being equivalent or similar to one another. Block 406 determines then whether a given software package is a dependency of the application. This determination may include, for example, determining a composition ratio and a containment ratio between the application and the software package and comparing these ratios to respective thresholds. If the composition ratio or the containment ratio exceeds its respective threshold, then block 406 may determine that the application depends on the matched software package.

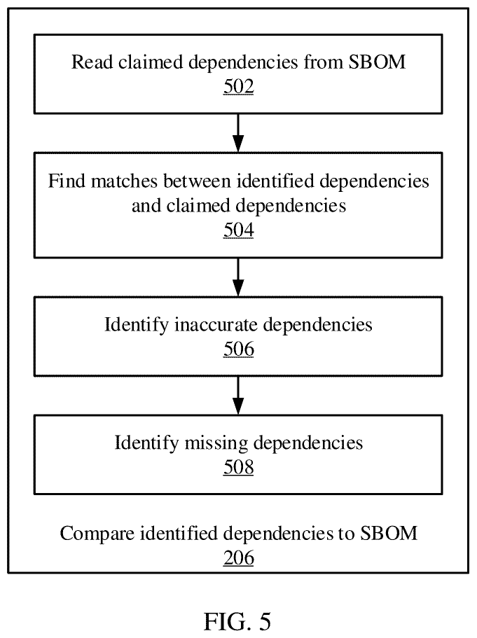

Referring now to FIG. 5, additional detail on the comparison of dependencies 206 is shown. Block 502 reads the claimed dependencies from an SBOM associated with the application. The SBOM may be provided by an application developer or other entity and may include package names and other information, such as version numbers and a link to a repository where the claimed dependency can be accessed (e.g., a package uniform resource locator (PURL)).

Block 504 finds matches between the claimed dependencies and dependencies that are identified by analysis of the application, for example from block 204. Block 506 identifies inaccurate dependencies, which are claimed by the SBOM but are not among those identified by analysis of the application, or which are imprecisely claimed (e.g., citing an incorrect version number). Block 508 identifies missing dependencies, which are identified by analysis of the application, but which are not claimed by the SBOM at all.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

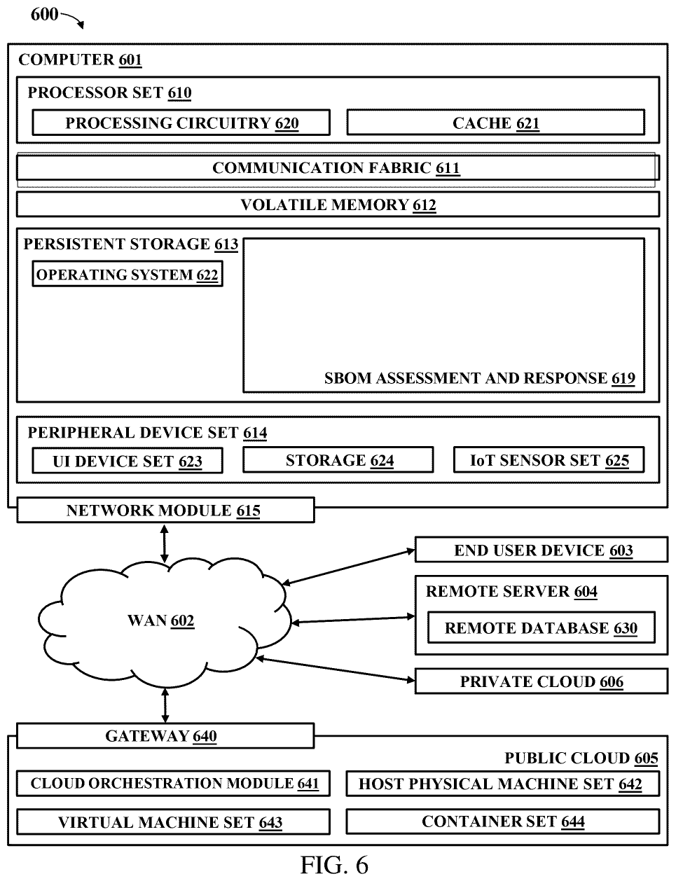

Referring now to FIG. 6, a block diagram of a computing environment is shown. Computing environment 600 contains an example of an environment for the execution of at least some of the computer code involved in performing the inventive methods, such as SBOM assessment and response 619. In addition to block 619, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 619, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible.

Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 619 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 619 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices.

Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Having described preferred embodiments of assessing SBOM accuracy and completeness (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for assessing a software bill of materials (SBOM), comprising:
building a knowledge graph from a plurality of repositories, using function fingerprints of software packages in the plurality of repositories;
identifying dependencies of an application using function fingerprints of the application and comparing to function fingerprints of the software packages;
generating a quality score for an SBOM of the application based on a comparison of the identified dependencies to claimed dependencies of the SBOM; and
performing an action responsive to the quality score.

2. The method of claim 1, wherein building the knowledge graph includes forming a vector database of the function fingerprints of the software packages, where each function fingerprint is represented as a respective vector embedding.

3. The method of claim 2, wherein identifying dependencies of the application includes querying the vector database with the function fingerprints of the application to determine software packages having similar function fingerprints.

4. The method of claim 3, wherein identifying dependencies of the application further includes determining similarity between function fingerprints using a cosine similarity metric.

5. The method of claim 1, wherein building the knowledge graph includes identifying components of the software packages and relationships between the components.

6. The method of claim 5, wherein the components include functions, files, libraries, packages, and images.

7. The method of claim 1, wherein the plurality of repositories include an open source repositories, a package manager, an official websites of a software package, and an internal repository for an organization.

8. The method of claim 1, wherein generating the quality score includes combining weight scores for a record, including a weight for missing or inaccurate dependencies and a weight for a scope of dependencies.

9. The method of claim 8, wherein generating the quality score includes dividing the combined weight scores by a maximum weight score across a number of dependencies.

10. The method of claim 1, wherein performing the action includes disabling execution of the application responsive to a quality score that is below a predetermined threshold.

11. A computer program product for assessing a software bill of materials (SBOM), the computer program product comprising a computer readable storage medium having program instructions embodied therewith, the program instructions being executable by a hardware processor to cause the hardware processor to:
build a knowledge graph from a plurality of repositories, using function fingerprints of software packages in the plurality of repositories;
identify dependencies of an application using function fingerprints of the application and comparing to function fingerprints of the software packages;
generate a quality score for an SBOM of the application based on a comparison of the identified dependencies to claimed dependencies of the SBOM; and
perform an action responsive to the quality score.

12. A system for assessing a software bill of materials (SBOM), comprising:
a hardware processor; and
a memory that stores a computer program which, when executed by the hardware processor, causes the hardware processor to:
build a knowledge graph from a plurality of repositories, using function fingerprints of software packages in the plurality of repositories;
identify dependencies of an application using function fingerprints of the application and comparing to function fingerprints of the software packages;
generate a quality score for an SBOM of the application based on a comparison of the identified dependencies to claimed dependencies of the SBOM; and
perform an action responsive to the quality score.

13. The system of claim 12, wherein the computer program further causes the hardware processor to form a vector database of the function fingerprints of the software packages, where each function fingerprint is represented as a respective vector embedding.

14. The system of claim 13, wherein the computer program further causes the hardware processor to query the vector database with the function fingerprints of the application to determine software packages having similar function fingerprints.

15. The system of claim 14, wherein the computer program further causes the hardware processor to determine similarity between function fingerprints using a cosine similarity metric.

16. The system of claim 12, wherein the computer program further causes the hardware processor to identify components of the software packages and relationships between the components.

17. The system of claim 16, wherein the components include functions, files, libraries, packages, and images.

18. The system of claim 12, wherein the plurality of repositories include an open source repository, a package manager, an official website of a software package, and an internal repository for an organization.

19. The system of claim 12, wherein the computer program further causes the hardware processor to combine weight scores for a record, including a weight for missing or inaccurate dependencies and a weight for a scope of dependencies.

20. The system of claim 19, wherein the computer program further causes the hardware processor to divide the combined weight scores by a maximum weight score across a number of dependencies.
